(19) United States
(12) Patent Application Publication
(10) Pub. No.: US 2010/0023351 A1
(43) Pub. Date: Jan. 28, 2010

(54) SYSTEM AND METHOD FOR AUTOMATED DIAGNOSTICS AND MEDICAL TREATMENT DEVELOPMENT FOR ORIENTAL MEDICINE

(76) Inventors: Georgiy Lifshits, Skokie, IL (US); Yosef Lifshits, Skokie, IL (US)

Correspondence Address: Richards Patent Law, 3501 N. Southport Ave., Suite 493, Chicago, IL, 60657, US

(21) Appl. No.: 12/510,151

(22) Filed: Jul. 27, 2009

Related U.S. Application Data
(60) Provisional application No. 61/084,069, filed on Jul. 28, 2008.

(51) Int. Cl. G06Q 50/00; G06N 5/02

(52) U.S. Cl. 705/3; 705/2; 706/54

(57) ABSTRACT

A method and a system for automated diagnostic and medical treatment development system for oriental medicine, wherein the system includes a controller, one or more associated databases and one or more user interfaces and the method includes the steps of: receiving a patient's medical complaint; electronically analyzing the complaint, the patient's medical history, oriental medicine recommendations to output an oriental medicine recommendation to address the patient's medical complaint; and optionally revising the analysis based on additional user input.

### CROSS-REFERENCE TO RELATED APPLCATIONS

This application incorporates by reference and claims priority to U.S. Provisional Patent Application No. 61/084,069 filed Jul. 28, 2008.

### TECHNICAL FIELD

The present subject matter relates generally to a system and method for automated diagnostic and medical treatment development. More specifically, the present invention relates to a method and a system for automated diagnostic and medical treatment development for oriental medicine.

### BACKGROUND OF THE INVENTION

Oriental medicine is the philosophy and science that views the human body as a set of complete, interconnected, systems that work together to achieve the proper function and health of the body. Although differing from one school of thought to another, the general concept relies on some superset of a subset of Yin, Yang, Qi, Blood, and/or the Zang-Fu organ or meridian system, as well as several other characteristics that determine health and illness in oriental medicine. Oriental medicine may also rely on the interactions of the Five Elements (i.e., Wood, Fire, Earth, Metal and Water). There are significant regional and philosophical differences between practitioners and schools which in turn can lead to differences in practice and theory. However, the term oriental medicine is an understood term of art for practitioners in the field.

One of the major difficulties in practicing oriental medicine, particularly the diagnosis and treatment processes, is the lack of information and the inability to process the vast information during a short amount of time limited by the patient visit. In order to successfully diagnose a patient, a lot of information has to be collected. Depending on the branch of oriental medicine practiced, the information collected could be quite expansive and varied (e.g., pulse readings, face readings, health questions, etc.).

Traditional diagnostic and treatment program techniques in oriental medicine rely on complex interplay between information provided by a patient and the observations of the practitioner. Until now, a successful treatment program has been dependent on, at least in part, the reliability and sufficiency of the patient data and the practitioner's observations, as well as the practitioner's ability to integrate the information within the time constraints of a patient visit. In other words, office visit time constraints limit the success of a practitioner's diagnosis and treatment program. Another limitation is the unreliability and insufficiency of the patient's answers, which can be exaggerated when the information is collected under the time limitation of the office visit and in the potentially disconcerting environment of the practitioner's office. Collecting a large enough set of data for the accurate diagnosis and treatment generation is difficult, time consuming and requires a lot of experience.

Further, the complexity of the diagnostic method can overwhelm even a well-versed practitioner. While the most common diagnoses and treatments are often at the front of a practitioner's mind, certain observed conditions, diagnoses and treatments occur less frequently and may be overlooked even when applicable. The result of inadequate or superficial analysis could be an oversimplification or overgeneralization of the patient's diagnosis, leading to a less accurate and less effective (even if correct) treatment. As a result, traditional diagnostic and treatment development techniques could be improved by incorporating a system and method whereby the complexities are captured and utilized.

Moreover, ongoing diagnostic and treatment programs pertaining to a given patient often rely on the quantity and quality of the records relating to that patient. Again, the time limitations of a patient's office visits can negatively impact the ability of the practitioner to generate and maintain comprehensive and reliable records.

In addition, a given practitioner's diagnostic and treatment plans may be improved over time by incorporating results feedback. Traditionally, the diagnostic and treatment feedback has been informal and difficult to effectively incorporate into the practitioner's practice.

Accordingly, a need exists for a system and method for automated diagnostic and medical treatment development for oriental medicine as described and claimed herein.

### BRIEF SUMMARY OF THE INVENTION

The subject matter disclosed herein addresses these issues by providing a method and system that allows for remotely collecting patient data, analyzing the entire data set using various algorithms based on oriental medicine theories, and providing the practitioner the raw data, as well as the post-analysis diagnosis and/or treatment recommendations. This system and method allow the practitioner to spend less time on collecting data and analyzing the minute details of every datum, freeing up the practitioner's time for the treatment and allowing the practitioner to focus on the other aspects of the office visit.

A method for use in oriental medicine includes the steps of: receiving electronic information from a patient relating to a medical complaint; accessing electronic information relating to the patient's medical complaint and oriental medicine recommendations; electronically analyzing the electronic information accessed to select one or more oriental medicine recommendations related to the patient's medical complaint; outputting the selected one or more oriental medicine recommendation; and allowing a user to provide additional electronic information such that any additional electronic information provided may be electronically analyzed in combination with accessed information relating to the patient's medical complaint and oriental medicine recommendations to select one or more oriental medicine recommendations related to the patient's medical complaint, wherein the selected one or more oriental medicine recommendations may be output.

A system for use in oriental medicine includes: a controller that receives electronic information from a patient relating to a medical complaint via a user interface; accesses electronic information relating to the patient's medical complaint and oriental medicine recommendations; electronically analyzes the electronic information accessed to select one or more oriental medicine recommendations related to the patient's medical complaint; outputs the selected one or more oriental medicine recommendation; and allows a user to provide additional electronic information such that any additional electronic information provided may be electronically analyzed in combination with accessed information relating to the patient's medical complaint and oriental medicine recommendations to select one or more oriental medicine recommendations related to the patient's medical complaint, wherein the selected one or more oriental medicine recommendations may be output.

A computer-readable medium having computer-executable instructions for use in oriental medicine, the computer-executable instructions causing the system to perform the steps of: receiving electronic information from a patient relating to a medical complaint; accessing electronic information relating to the patient's medical complaint and oriental medicine recommendations; electronically analyzing the electronic information accessed to select one or more oriental medicine recommendations related to the patient's medical complaint; outputting the selected one or more oriental medicine recommendation; and allowing a user to provide additional electronic information such that any additional electronic information provided may be electronically analyzed in combination with accessed information relating to the patient's medical complaint and oriental medicine recommendations to select one or more oriental medicine recommendations related to the patient's medical complaint, wherein the selected one or more oriental medicine recommendations may be output.

An advantage of the method and system provided herein is the ability to store and transmit electronic medical records, diagnoses, and treatments.

Another advantage of the method and system provided herein is the ability to collect information outside of the confines of an office visit, which encourages and enables the utilization of a greater amount of information than is typically possible.

A further advantage of the method and system provided herein is the practitioner is able to monitor the state and progress of the patient between treatments and also the patients may pose questions to the practitioner at any time.

Additionally, an advantage of the method and system provided herein is the patient is able to provide the information to the practitioner on the patient's time and in a comfortable setting.

Moreover, an advantage of the method and system provided herein is the practitioner gets the advantage of utilizing statistical modeling assisting the diagnosis and treatment plans.

Another advantage of the method and system provided herein is that the method and system may be utilized to provide patient-practitioner matching, for example, using such factors as location, specialties, complaints, etc.

Yet another advantage of the method and system provided herein is that by the time patient arrives at a practitioner's office, the practitioner may be well-prepared for the session and have a significantly better understanding of the patient's needs.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BREIF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a block diagram of a system for automated diagnostic and medical treatment development for oriental medicine.

FIG. 2 is a flow chart of a method for automated diagnostic and medical treatment development for oriental medicine.

FIG. 3 is a flow chart of an embodiment of a portion of the method for automated diagnostic and medical treatment for oriental medicine.

FIGS. 4a-4c illustrate a flow chart of an embodiment of a portion of the method for automated diagnostic and medical treatment for oriental medicine.

### DETAILED DESCRIPTION OF THE INVENTION

A method for use in oriental medicine includes the steps of: receiving electronic information from a patient relating to a medical complaint; accessing electronic information relating to the patient's medical complaint and oriental medicine recommendations; electronically analyzing the electronic information accessed to select one or more oriental medicine recommendations related to the patient's medical complaint; outputting the selected one or more oriental medicine recommendation; and allowing a user to provide additional electronic information such that any additional electronic information provided may be electronically analyzed in combination with accessed information relating to the patient's medical complaint and oriental medicine recommendations to select one or more oriental medicine recommendations related to the patient's medical complaint, wherein the selected one or more oriental medicine recommendations may be output.

A system for use in oriental medicine includes: a controller that receives electronic information from a patient relating to a medical complaint via a user interface; accesses electronic information relating to the patient's medical complaint and oriental medicine recommendations; electronically analyzes the electronic information accessed to select one or more oriental medicine recommendations related to the patient's medical complaint; outputs the selected one or more oriental medicine recommendation; and allows a user to provide additional electronic information such that any additional electronic information provided may be electronically analyzed in combination with accessed information relating to the patient's medical complaint and oriental medicine recommendations to select one or more oriental medicine recommendations related to the patient's medical complaint, wherein the selected one or more oriental medicine recommendations may be output.

A computer-readable medium having computer-executable instructions for use in oriental medicine, the computer-executable instructions causing the system to perform the steps of: receiving electronic information from a patient relating to a medical complaint; accessing electronic information relating to the patient's medical complaint and oriental medicine recommendations; electronically analyzing the electronic information accessed to select one or more oriental medicine recommendations related to the patient's medical complaint; outputting the selected one or more oriental medicine recommendation; and allowing a user to provide additional electronic information such that any additional electronic information provided may be electronically analyzed in combination with accessed information relating to the patient's medical complaint and oriental medicine recommendations to select one or more oriental medicine recommendations related to the patient's medical complaint, wherein the selected one or more oriental medicine recommendations may be output.

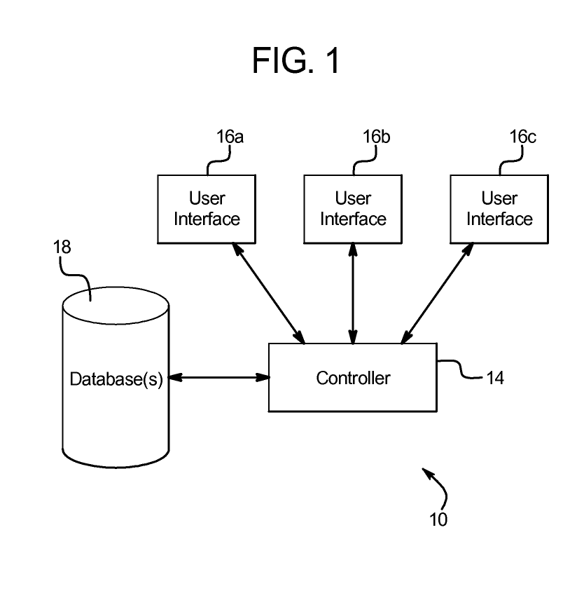

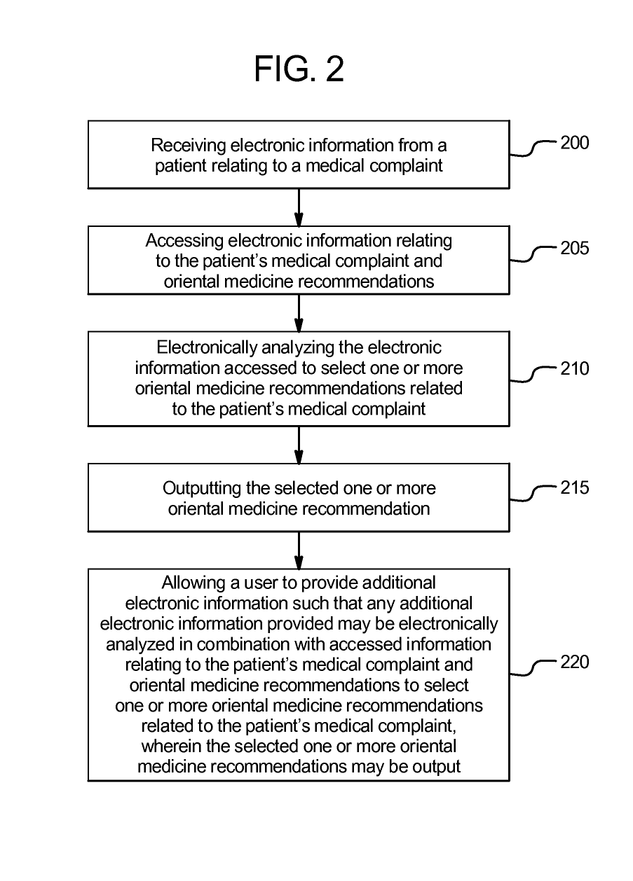

FIG. 1 illustrates a system for automated diagnostic and medical treatment development for oriental medicine 10 (the system 10). FIG. 2 illustrates a method for automated diagnostic and medical treatment development for oriental medicine 10 (the method 12).

As shown in FIG. 1, the system 10 includes a controller 14, a plurality of associated user interfaces 16 and one or more associated databases 18. The controller 14 runs a variety of application programs, accesses and stores data, and enables one or more interactions via the user interfaces 16 provided. While further description of the controller 14 is provided below, it is understood that the controller 14 may be embodied in any one or more electronic systems arranged to control the electronic aspects of the system 10 and the method 12 described herein.

Users interact with the system 10 via respective user interfaces 16. For example, in the embodiment described with reference to FIG. 2, a patient interacts with the system 10 via a first user interface 16a, while a practitioner interacts with the system 10 via a second user interface 16b. In addition, in portions of the system 10 and the method 12 described herein, one or more additional users may interact with the system 10 via additional interfaces 16c. Accordingly, it is understood that there may be any number of additional user interfaces 16 that may be utilized by any number of additional users. Moreover, it is understood that each given user may access and interact with the system 10 via a plurality of user interfaces 16. For example, a patient may access the system 10 a first time via a first computer and then access the system 10 a second time via a second computer. In this example, both the first computer and the second computer may be considered the first user interface 16a. Consequently, the use of the terms first user interface 16a and second user interface 16b are merely intended to draw a non-numerical distinction between user interfaces 16 used by distinct users. It is also understood that a given patient may not have access to a user interface 16, and, in such a case, the patient input to the system 10 may be routed through the practitioner's user interface 16 or another user interface 16. As a result, it is contemplated that all of the input into the system 10 described herein, may in some cases occur through a single user interface 16.

As shown in FIG. 1, the system 10 includes one or more databases 18. The one or more databases 18 store information relating to the operation of the system 10 and method 12 as described herein. The one or more databases 18 may be integrated with the controller 14 or may be independent of the controller 14. The structure and operation of the one or more databases 18 will be understood to one having ordinary skill in the art given the context of the description of the system 10 and the method 12 provided herein. Further, for purposes of this patent application, the phrase one or more databases 18 should be read to include any mechanism for storing, relating, organizing and retrieving data. It is also understood that in some contemplated embodiments of the system 10 and method 12 the information storage and relationships may be inherent in the programming code, without the use of one or more databases 18.

Turning now to FIG. 2, the method 12 is shown including the following steps: receiving electronic information from a patient relating to a medical complaint 200 (step 200); accessing electronic information relating to the patient's medical complaint and oriental medicine recommendations 205 (step 205); electronically analyzing the electronic information accessed to select one or more oriental medicine recommendations related to the patient's medical complaint 210 (step 210); outputting the selected one or more oriental medicine recommendation 215 (step 215); and allowing a user to provide additional electronic information such that any additional electronic information provided may be electronically analyzed in combination with accessed information relating to the patient's medical complaint and oriental medicine recommendations to select one or more oriental medicine recommendations related to the patient's medical complaint, wherein the selected one or more oriental medicine recommendations may be output 220 (step 220). It is contemplated that the steps illustrated in FIG. 2 are merely one embodiment of the method 12. The method 12 may include fewer and/or additional steps as described herein.

The system 10 and method 12 provide automated diagnostic and medical treatment development for oriental medicine. The system 10 and method 12 enable information necessary for diagnosis and treatment of a patient to be compiled remotely in comfortable and stable conditions, not limited by time. The information collection is followed by the transmission of the information into the computerized analytical system, which then analyzes the information and determines and outputs a diagnosis of the patient's illness and a plan for treatment. Thus, the patient may, at any time available prior to an appointment, prepare the information necessary for diagnosis and the practitioner can then receive the diagnosis for the patient, as well as a plan and prescription for treatment for that particular patient. The system 10 and method 12 enable patients and practitioners to begin the evaluation and treatment process independent of their respective locations and may be particularly convenient for communication between a patient and a practitioner who, for instance, speak different languages.

In various embodiments of the system 10 and the method 12 described herein, the patient may have the ability to choose a practitioner based on the location of the office, specialties, and/or other related criteria. For example, when accessing the system 10, a user may provide information that is used by the controller 14 to match the user with a practitioner, including requesting the patient to select one of the associated practitioners, as described further herein.

Through the system 10 and method 12 described herein, a selected practitioner may have access to information relating to the patient's medical history, symptoms, diagnosis, and the proposed plan and prescription for treatment for the patient by which he was chosen. The practitioner may have the ability to fine-tune or change the diagnosis and plan of treatment proposed based on his own observations and medical expertise as further described herein.

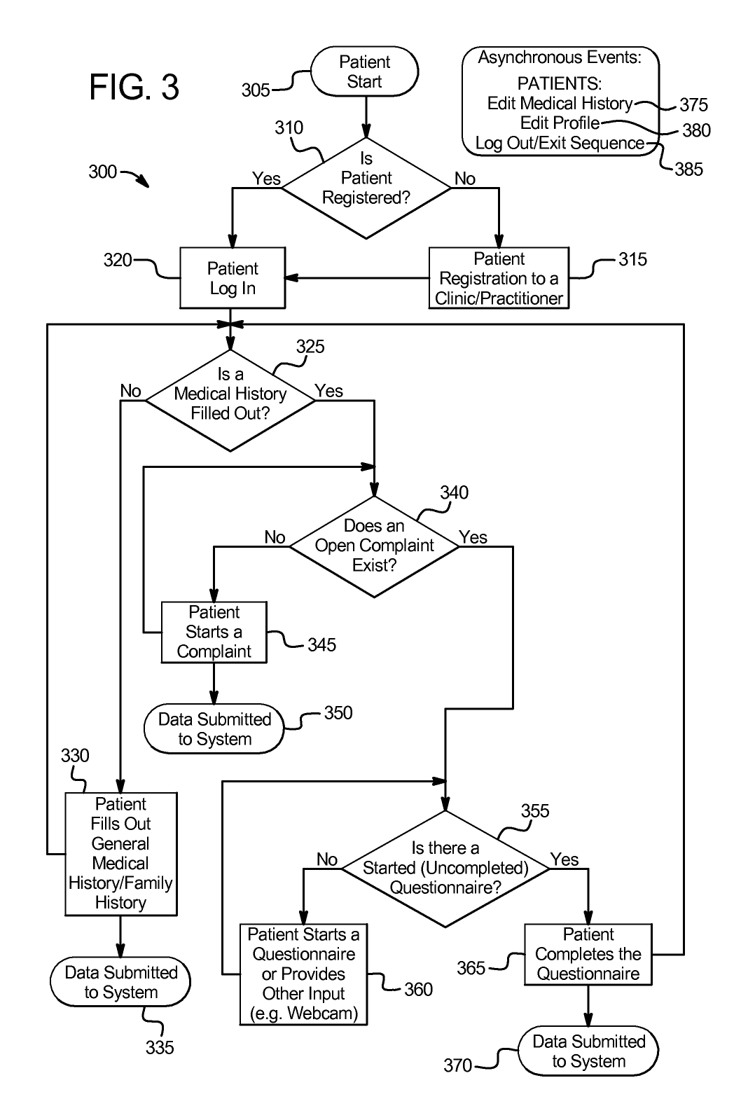

FIG. 3 illustrates a patient logic flow 300 from a patient's perspective for preparing and submitting the information that is received by the system 10 in step 20 of the method 12. FIG. 3 is merely one example of a corresponding patient logic flow 300 and it is understood that numerous alternatives may be developed by one having ordinary skill in the art based on the disclosure herein. The patient logic flow 300 shown in FIG. 3, may be carried out by the patient via a personal computer functioning as a user interface 16. However, it is contemplated that any device functioning as a user interface 16 may be used by a patient following the patient logic flow 300.

As shown in FIG. 3, a patient may begin the patient logic flow 300 at step 305. Next the system 10 may determine whether the patient is a registered user in step 310. If the patient is not a registered user, the patient may be registered to a clinic or a practitioner in step 315. The step of registering the patient to a clinic or practitioner may include enabling the patient to select a clinic or practitioner from a provided list; it may include automatically selecting a clinic or practitioner for the patient, etc. Further, step 315 may include collecting information (e.g., name, contact information, etc.) about the patient and assigning a user name and a password to the patient. When the patient is a registered patient, the patient may log in via step 320. The information collected in step 315 may be used to create a profile for the user. The user profile may be subsequently linked to medical history records, complaints and questionnaires as described herein. The registration process and user profile are used to identify users and establish their credentials.

Step 320 may require the patient to provide a registered user name and the associated password or may require any other authentication necessary to confirm the patient's identity within the system. Once the patient is authenticated, the patient may be asked whether a medical history has been completed in step 325. If the patient has not completed a medical history, the patient may provide such information in step 330. The step of providing a medical history may include answering predetermined questions presented to the patient as well as providing other patient history related information such as patient notes, pictures, videos, charts, electronic medical records, etc. The medical history may take into account the patient's physical parameters (e.g., gender, age, height, weight, eye color, hair color, etc.), environmental factors (e.g., location, place and date of birth, nationality, etc.) and other factors, which may be useful for diagnosis or treatment. In one example, the patient medical history may include: general information (e.g., name, phone number, address, weight, height, occupation, etc.); family health issues information (e.g., alcoholism, allergies, cancer, diabetes, epilepsy, heart disease, high blood pressure, stroke, etc.); personal medical history information (e.g., accidents, injuries, traumas, allergies, cancer, diabetes, epilepsy, high blood pressure, hyperactive thyroid, hypoactive thyroid, joint diseases, low blood pressure, medication in use, scars, surgeries, etc.); information about habits (e.g., addictive drugs, alcoholism, cups of coffee per day, excessive salt, excessive sugar, number of cigarettes per day, number of soft drinks per day, etc.). These examples are illustrative and it is understood that the examples provided herein will enable one having ordinary skill in the art to provide numerous variations and degrees of comprehensiveness regarding the medical history information collected. The provided medical history may then be submitted to the system 10 in step 335.

When the patient's medical history has been submitted to the system 10, the patient may be asked whether an open complaint exists in step 340. An open complaint may be any reason for which the patient seeks treatment from the practitioner. If an open complaint does not exist in the system 10, the patient may provide one in step 345. In one example, a patient complaint may include information regarding patient symptoms and the dates on which those symptoms occurred. In addition, patient comments may be submitted as part of the complaint. Further, a patient complaint may include any information a practitioner may use to begin a diagnosis and treatment program, including, for example, audio, video, photographic, biometric, bioelectric and other inputs. For example, speech recognition and analysis may be utilized in the collection of patient complaint. Once the patient complaint has been prepared, it may be submitted to the system 10 in step 350.

When an open complaint exists, the patient may be prompted to complete a questionnaire relating to the open complaint in step 355. The questionnaire may request additional information relating to the open complaint. For example, the questionnaire may provide a number of symptoms associated with the open complaint and request the patient provide a subjective rating for the severity or duration of each symptom to indicate which symptoms are present and to what degree. For example a numerical ranking could be assigned for each symptom to allow a patient to quickly and comparatively describe the symptoms. In addition, the questionnaire may request specific information from the patient, such as, for example, for the patient to provide a photograph of a specific body part or other visual information. Additionally, if a patient has a specific health issue, that patient may complete one or more specific symptom modules that relates to the one or more symptoms, which may further take into account subjective severity of the one or more symptoms and any objective information the patient may provide. Further, the questionnaire may include requests for any information a practitioner may use to begin a diagnosis and treatment program, including, for example, audio, video, photographic, biometric, bioelectric and other inputs. When the questionnaire is completed in step 365, the information is submitted to the system 10 in step 370 and the patient logic flow 300 may restart, for example, by returning to step 325.

At any point within the patient logic flow 300 (and the practitioner logic flow 400 described below), the information collected may be saved and updated. Accordingly, if an electronic connection is lost, minimal information will be lost in the process.

In addition to the steps of the patient logic flow 300 described above, there may be other asynchronous steps. For example, as shown in FIG. 3, a patient may edit their medical history records in step 375, edit their profile in step 380 or initiate a log out sequence in step 385.

As described above with reference to FIG. 3, information may be submitted to the system 10 in various steps, including, but not limited to steps 335, 350, 370. The information submitted to the system 10 may be received by the controller 14 and stored in the one or more associated databases 18 as described herein. It is contemplated that some patients will access the system 10 via a personal computer functioning as a user interface 16. However, it is also understood that some patients will not have access to a personal computer and that their information may be collected and converted to an electronic format. For example, the information collection described with respect to FIG. 3 may be performed using a machine readable paper system, such as, for example, one of the machine readable paper system sold under the trademark Scantron.

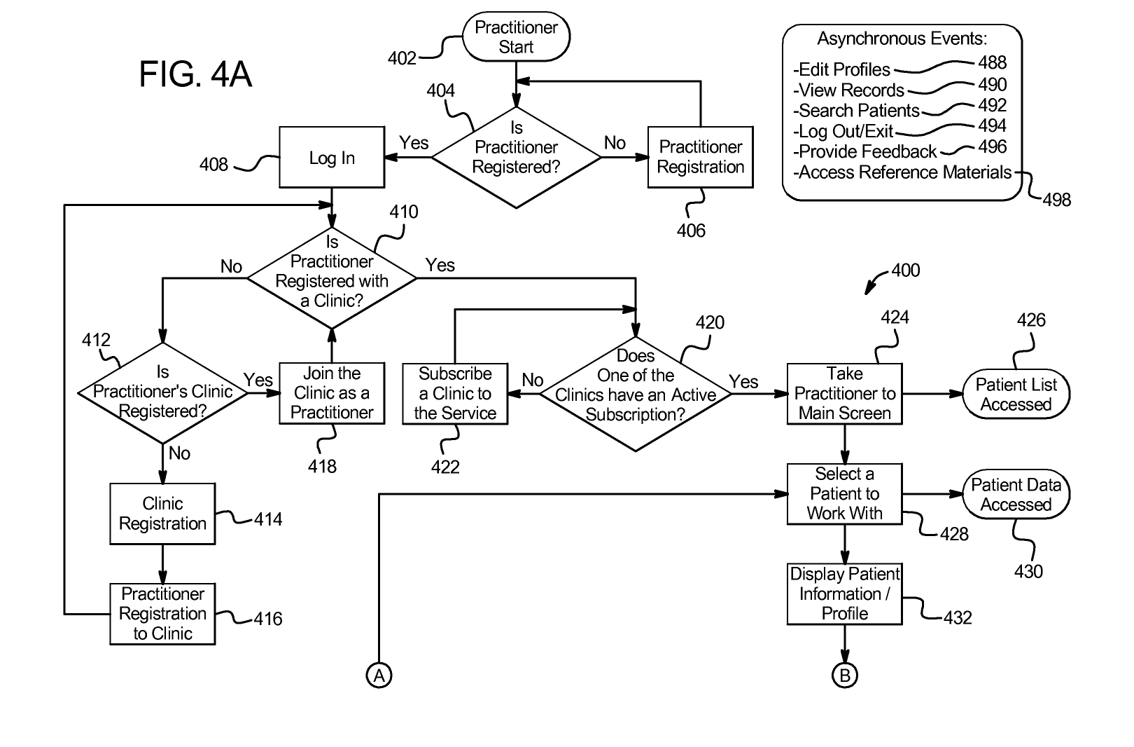

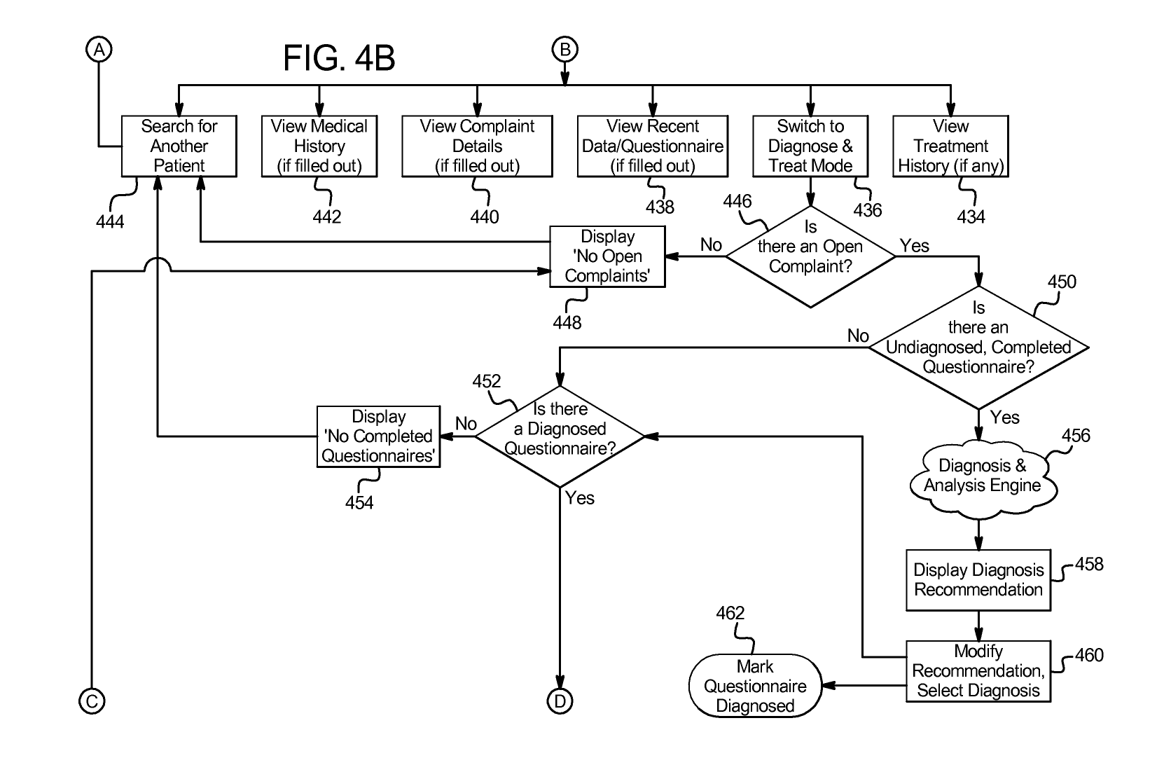

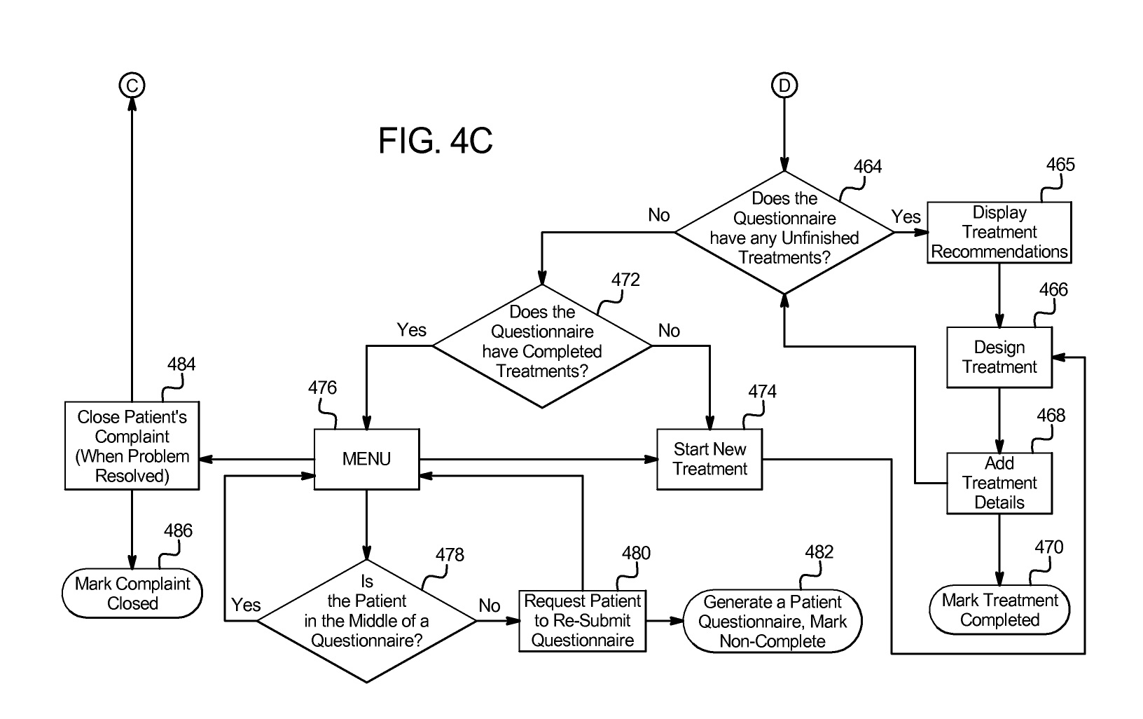

FIGS. 4a-4c illustrate a practitioner logic flow 400 from a practitioner's perspective for participating in the system 10 and the method 12 described herein. FIGS. 4a-4c illustrate merely one example of a corresponding practitioner logic flow 400 and it is understood that numerous alternatives may be developed by one having ordinary skill in the art based on the disclosure herein. The practitioner logic flow 400 shown in FIGS. 4a-4c, may be carried out by the practitioner via a personal computer functioning as a user interface 16. However, it is contemplated that any device functioning as a user interface 16 may be used by a practitioner following the practitioner logic flow 400. It is also contemplated that the user interface 16 used by the practitioner may be the same as or different from the user interface 16 used by the patient, depending on the context in which it is used. However, it is understood that one advantages of the system 10 and method 12 described herein is the ability to compile the information, at least in part, away from the office visit, temporally and/or geographically.

As shown in FIGS. 4a-4c, a practitioner may begin the practitioner logic flow 400 at step 402. Next the practitioner may be asked whether he or she is a registered user in step 404. If the practitioner is not a registered user, the practitioner may be registered in step 406. The step of registering the practitioner may include collecting information about the practitioner and assigning a user name and a password to the practitioner. For example, the system 10 may collect the practitioner's name, contact information, clinic information, payment information, etc. The central element of registration process is generating authentication credentials (e.g., username and password, biometic credentials, etc.)

It is contemplated that the practitioner logic flow 400 may collapse the example registration steps shown in FIGS. 4a-4c into a quick registration process in which all of steps 404-424 are merged in a single logic step. Regardless of the structure of the initial registration process, when the practitioner is a registered practitioner, the practitioner may log in via step 408.

In step 410 it may be determined whether the practitioner is registered with a clinic in the system 10. If the practitioner is not registered with a clinic in the system 10, it may be determined whether the practitioner's clinic is registered in the system 10 in step 412. If the practitioner's clinic is not registered in the system 10, the practitioner's clinic may be registered into the system in step 414. Similar to the practitioner registration, the clinic registration may include collecting information about the clinic, such as, for example, address, contact information, specialties, practitioners, etc. The collected information is then used to create a record for the clinic in the system 10. Once the practitioner's clinic is registered in the system 10 via step 414, the practitioner may be registered to the clinic in step 416. Step 416 may include associating the clinic registration records in the one or more databases 18 with the practitioner registration records. In one example, a practitioner may only be registered to a clinic with approval of the clinic owner or administrator.

If the practitioner's clinic was determined to be registered in the system 10 in step 412, the practitioner may be registered to the clinic in step 418. Associating a practitioner and clinic in step 418 may be accomplished similarly to step 416, as described herein.

When the practitioner is registered to a clinic in the system 10, it can be determined whether the clinic has a subscription to the system 10 and method 12 in step 420. If the clinic is not a subscribing clinic, the clinic may initiate a subscription in step 422. The step of subscribing to the system 10 and method 12 may include selecting a service plan, payment method, billing cycle, etc.

When a practitioner's clinic is registered to system 10 and method 12, the practitioner may be taken to the main program screen in step 424 and the patient list may be accessed in step 426. The patient list may include a listing of each of the patients associated with the practitioner's clinic for which patient records exist in the system 10.

A practitioner may then select a patient with which to work in step 428 and the patient data may be accessed in step 430. The patient data may then be displayed for the practitioner in step 432. Upon viewing the patient data, the practitioner may then: view the treatment history (if any) in step 434; switch to diagnose and treat mode in step 436; view recent patient data and/or questionnaire (if filled out) in step 438; view complaint details (if filled out) in step 440; view medical history (if filled out) in step 442; or search for another patient in step 444. If the practitioner chooses to search for another patient in step 444, the practitioner is sent back to step 428, as shown in FIGS. 4a-4c.

If the practitioner chooses to enter diagnose and treat mode via step 436, it may be determined whether there is an open complaint for the selected patient in step 446. If there are no open complaints for the selected patient, the system 10 may indicate to the practitioner that there are no open complaints in step 448 and the practitioner may be returned to step 444 to search for another patient. However, if there is an open complaint for the selected patient, it may be determined whether there is an undiagnosed completed questionnaire in step 450.

If there is not an undiagnosed completed questionnaire, it may be determined whether there is a diagnosed questionnaire for the patient in step 452. If there is not, the system 10 displays to the practitioner that there is no questionnaire completed in step 454 and then returns to step 444 to enable the practitioner to search for another patient.

However, if there is an undiagnosed completed questionnaire found in step 450, the system 10 begins the analysis engine in step 456, as described further herein. The analysis engine outputs a diagnosis recommendation, which is displayed to the practitioner in step 458. The practitioner may then review the diagnosis recommendation, modify the recommendations by providing additional or revised input, and select a diagnosis recommendation in step 460. After a selection is made, the questionnaire may be marked diagnosed in step 462. The practitioner logic flow 400 then proceeds to step 452.

The diagnosis recommendation may include, for example, the statistical probability of the diagnosis as determined by the analysis engine, corresponding symptoms and whether the diagnosis is the primary or an underlying diagnosis. For example, the diagnosis recommendation may be “Phlegm Fire in the Heart” with an indicated probability of 69.52%, with listed pulse symptoms such as, full, rapid, slippery or rapid, overflowing, full, wiry, etc., and listed tongue symptoms such as, red, yellow-sticky, midline crack with yellow prickles in it, the tip may be redder, etc. In step 460, the practitioner may revise the diagnosis, for example, by providing additional information, editing whether the diagnosis is the primary or an underlying diagnosis, adding comments, etc. The practitioner may further revise the diagnosis by selecting or deselecting individual diagnoses, for example, based on the given probability and/or re-running the analytic engine based on additional information.

If a diagnosed questionnaire is found in step 452, the system 10 may determine whether there are any unfinished treatments associated with the diagnosed questionnaire in step 464. If there are unfinished treatments, the practitioner may view the treatment recommendation in step 465, continue to design the treatment in step 466, add treatment details in step 468, mark the treatment complete in step 470 and return to step 464.

The treatment recommendations may be provided by the analysis engine as it associated the identified diagnoses with appropriate treatments. The provided treatment plan may include, for example, acu-point stimulation (acupuncture, acupressure, moxa, laser, electro, thermal, acoustic/sound, light, injection, etc.), herbal recommendations, nutritional recommendations, dietary recommendations, food recipes, physical activity/exercise recommendations, mental exercise recommendations, a list of the identified symptoms, etc. In each section, the treatment plan may identify the one or more associated diagnoses for which the treatment is targeted. For example, within an acupuncture section, for a given diagnosis, there may be recommendations for points, techniques, whether or not to use a special modality, etc. The practitioner may then modify the treatment plan using one of the user interfaces 16, for example, by inputting additional information or by providing additional treatment steps.

For example, for the “Phlegm Fire in the Heart” diagnosis example provided above, the corresponding treatment plan may include the explanation that the treatment is intended to clear the Heart Fire, resolve Phlegm and calm the mind. The treatment plan may further, for example, identify using the tonifying technique on BL-20 (the Back Shu point of the Spleen; tonifies the Spleen and promotes and invigorates the Spleen's function in the transformation of phlegm) and REN-12 (tonifies the Spleen and transforms phlegm). The treatment plan may also, for example, identify using the sedating technique on BL-15 (the Back Shu point of the Heart; clears the heart) and HE-9 (bleeding the Wood point of the Heart channel; clears the Heart).

In steps 466 and 468 the practitioner may develop the treatment and add treatment details, for example, by selecting the specific treatments to implement from among the treatments presented or adding additional information and/or treatments. For example, the practitioner may add an additional acupuncture point by selecting the meridian, the point for the chosen meridian, the modality, the technique and the side. Similarly, herbal treatments may be selected, added, modified or otherwise developed. Additionally, the treatment plan may be further developed as will be apparent to one having ordinary skill in the art.

Alternatively, if the questionnaire is determined to include no unfinished treatments in step 464, the system 10 may determine whether the questionnaire has any completed treatments in step 472. If there are no completed treatments, the practitioner may start a new treatment in step 474 and return to step 465. However, if there are completed treatments, the practitioner may be sent to a menu in step 476. From the menu, the practitioner may, for example, start a new treatment via step 474, determine whether the patient is in the process of completing a questionnaire in step 478 or close the patient's complaint (if the problem has been resolved) in step 484. If the patient is not in the process of completing a questionnaire the practitioner may request the patient re-submit a new the questionnaire in step 480, generate a patient questionnaire and mark it non-complete in step 482, before returning to the menu in step 476. If the patient's complaint is closed in step 484, the complaint may be marked closed in step 486 and the practitioner logic flow 400 may return to step 448.

As described above with reference to FIGS. 4a-4c, the system 10 and method 12 utilize an analysis engine to prepare the diagnosis and the treatment plan. The analysis engine may be resident in the controller 14 and may make use of the one or more databases 18 for the analysis. For example, the one or more databases 18 may include: patient information (e.g., patient registration information collected in step 315, patient medical history information collected in step 335, patient complaint information collected in step 350, patient questionnaire information collected in step 370, etc.); practitioner information (e.g., practitioner registration information collected in step 406; clinic registration information collected in steps 414 and 416, clinic subscription information collected in step 422, etc.); questionnaire, diagnosis and treatment status information (e.g., information collected, for example, in steps 458, 460, 462, 466, 468, 470, 480, 482 and 486); symptom information (e.g., information relating to specific illness symptoms, general symptoms, and modules of grouped illness symptoms, such as, for example, gastrointestinal, gynecological, psychological, etc.); compilations of diagnoses and treatment plans related to the diagnoses; compilations of correlations of the various oriental medicine diagnoses to western medicine diagnoses; treatment results and related information; information regarding the practitioners participating in the system 10 and method 12. However, it is understood that the one or more databases 18 described herein may include any additional information as will be apparent to one of ordinary skill in the art. Moreover, the structure of the one or more databases 18 may vary by application and will be apparent to one of ordinary skill in the art.

The controller 14 may implement the analysis engine to prepare a diagnostic and treatment plan as described above with respect to step 456. The controller 14 operates a programmed routine that accesses some subset of the information stored in the one or more databases 18 (as described above) and prepares a diagnosis and associated treatment plan based on algorithms based on theories of oriental medicine. Depending on the parameters applied, the analysis may identify a single diagnosis or several diagnoses and a single corresponding treatment plan or several treatment plans. It is understood that any combination of singular or plural diagnoses and treatments may be identified by the controller 14. In one example, the diagnoses and treatment plans may be displayed to the practitioner in a manner that relates the parameters that prompted the identification of each identified diagnosis and treatment plan.

To minimize coincidental factors and to minimize the influence of (potentially inaccurate) subjective ratings by the patient of their symptoms, the analysis engine uses statistical modeling based on the theories of oriental medicine to analyze the information. The analysis engine also takes into account the weights (if any) of each symptom on the formulation of diagnosis for the patient and for the treatment plan.

Although the initial diagnosis is generated in step 456, the analysis engine may include the ability for the practitioner to refine the diagnosis in step 460. For example, system modules used for the analysis may allow fine-tuning, and arranging of data and formulation of the diagnosis from the data.

The system 10 and method 12 also have the ability to take into account the diagnosis of Western Medicine and the ability to generate an enhanced diagnosis based on the inclusion of such information. Further, the system 10 and method 12 have the ability to take into account objective methods of treatment for the identification of contraindicated methods of treatment.

As shown in the patient logic flow 300 and practitioner logic flow 400, if they choose to do so, the patient and practitioner can report their rating of the treatment results into the system 10 via step 496. Similarly, over time the analysis engine may accumulate information in the one or more databases 18 about the patient, the patient's symptoms, diagnoses, methods and results of treatment. Using this accumulated information, the system 10 and method 12 have the ability to improve the diagnosis and the treatment plan results. The information accumulated in the one or more databases 18 also allows for research studies to help increase the accuracy of the diagnosis and the effectiveness of the treatment plans.

Other asynchronous events shown in FIGS. 4a-4c include: the practitioner is able to edit the practitioner and clinic registrations profiles in step 488; the practitioner may view any of the electronic records in step 490; and the practitioner may search the patients' records in step 492; the practitioner may log off and exit the system in step 494. Additionally, the one or more databases 18 in the system 10 may include reference materials for the practitioner to access in step 498. For example, the system 10 may include a database of acupuncture points, location descriptions, including pictorial representations of each point and the ability to reference the WHO standard point locations.

The system 10 and method 12 described herein present a number of advantages for the patients and the practitioners. For example, the practitioner has the ability to store the full treatment protocols and can print them or send them electronically as needed. In fact, all of the records can be stored electronically and may be transferred to other clinics, practitioners, specialists, etc. if desired. Further, the system 10 and method 12 allow users (both patients and practitioners) to discuss the results, symptoms, and other aspects of the treatment cycle in a secure environment. Also, due to the ability to collect information outside of the confines of an office visit, the system 10 and method 12 encourage and enable the utilization of a greater amount of information than is typically possible. This allows the practitioner to monitor the state and progress of the patient between treatments and also allows the patients to pose questions to the practitioner at any time. Additionally, the patient is able to provide the information to the practitioner on the patient's time and in a comfortable setting. The practitioner gets the advantage of utilizing statistical modeling assisting the diagnosis and treatment plans.

Further, the system 10 and method 12 may be utilized to provide patient-practitioner matching, for example, using such factors as location, specialties, complaints, etc. Another advantage of the system 10 and method 12 is that by the time patient arrives at a practitioner's office, the practitioner may be well-prepared for the session and have a significantly better understanding of the patient's needs. Additionally, due to the electronic nature of the system 10 and method 12, the system 10 and method 12 may dynamically translate the patient's input into the practitioner's preferred language.

Moreover, the system 10 and method 12 also allow for the transmission of, formatted in any way, information for use in other modules (e.g., medical billing systems, scheduling systems, etc.). The optional addition of such modules allows the system 10 to fully automate and converge all functions of a medical office in the area of oriental medicine.

Oriental medicine recommendation, as used in this patent, encompasses one or more oriental medicine diagnoses and/or one or more oriental medicine treatment plans. For example, one or more oriental medicine diagnoses is an oriental medicine recommendation. Also, one or more oriental treatment plans is an oriental medicine recommendation. Further, a combination of one or more oriental medicine diagnoses and one or more oriental treatment plans is an oriental medicine recommendation.

As shown by the above discussion, aspects of the system for automated diagnostic and medical treatment development for oriental medicine 10 are controlled by a controller 14. As described above, the controller 14 runs a variety of application programs, accesses and stores data, including accessing and storing data in associated databases 18, and enables one or more interactions via the user interfaces 16 provided. Typically, the controller 14 is implemented by one or more programmable data processing devices. The hardware elements operating systems and programming languages of such devices are conventional in nature, and it is presumed that those skilled in the art are adequately familiar therewith.

For example, the controller 14 may be a PC based implementation of a central control processing system utilizing a central processing unit (CPU), memories and an interconnect bus. The CPU may contain a single microprocessor, or it may contain a plurality of microprocessors for configuring the CPU as a multi-processor system. The memories include a main memory, such as a dynamic random access memory (DRAM) and cache, as well as a read only memory, such as a PROM, an EPROM, a FLASH-EPROM, or the like. The system also includes mass storage devices such as various disk drives, tape drives, etc. In operation, the main memory stores at least portions of instructions for execution by the CPU and data for processing in accord with the executed instructions.

The controller 14 may also include one or more input/output interfaces for communications with one or more processing systems. Although not shown, one or more such interfaces may enable communications via a network, e.g., to enable sending and receiving instructions electronically. The physical communication links may be wired or wireless.

The controller 14 may further include appropriate input/output ports for interconnection with one or more output displays (e.g., monitors, printers, etc.) and one or more input mechanisms (e.g., keyboard, mouse, voice, touch, bioelectric devices, etc.) serving as one or more user interfaces 16 for the controller 14. For example, the controller 14 may include a graphics subsystem to drive the output display. The links of the peripherals to the system may be wired connections or use wireless communications.

Although summarized above as a PC-type implementation, those skilled in the art will recognize that the controller 14 also encompasses systems such as host computers, servers, workstations, network terminals, and the like. In fact, the use of the term controller 14 is intended to represent a broad category of components that are well known in the art.

Hence aspects of the system 10 and the method 12 discussed herein encompass hardware and software for controlling the relevant functions. Software may take the form of code or executable instructions for causing a controller 14 or other programmable equipment to perform the relevant steps, where the code or instructions are carried by or otherwise embodied in a medium readable by the controller 14 or other machine. Instructions or code for implementing such operations may be in the form of computer instruction in any form (e.g., source code, object code, interpreted code, etc.) stored in or carried by any readable medium.

As used herein, terms such as computer or machine “readable medium” refer to any medium that participates in providing instructions to a processor for execution. Such a medium may take many forms, including but not limited to, tangible storage media, as well as carrier wave and tangible transmission media. Non-volatile storage media include, for example, optical or magnetic disks, such as any of the storage devices in any computer(s) shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

It should be noted that various changes and modifications to the presently preferred embodiments described herein will be apparent to those skilled in the art. Such changes and modifications may be made without departing from the spirit and scope of the present invention and without diminishing its attendant advantages.

We claim:

1. A method for use in oriental medicine comprising the steps of:
receiving electronic information from a patient relating to a medical complaint;
accessing electronic information relating to the patient's medical complaint and oriental medicine recommendations;
electronically analyzing the electronic information accessed to select one or more oriental medicine recommendations related to the patient's medical complaint;
outputting the selected one or more oriental medicine recommendation; and
allowing a user to provide additional electronic information such that any additional electronic information provided may be electronically analyzed in combination with accessed information relating to the patient's medical complaint and oriental medicine recommendations to select one or more oriental medicine recommendations related to the patient's medical complaint, wherein the selected one or more oriental medicine recommendations may be output.

2. The method of claim 1 the oriental medicine recommendation is an oriental medicine diagnosis.

3. The method of claim 1 the oriental medicine recommendation is an oriental medicine treatment plan.

4. The method of claim 1 wherein the electronic information received from the patient is received via a first user interface and the diagnoses and treatment plan is output via a second user interface.

5. The method of claim 1 wherein the electronic information received from the patient includes biometric, audio/video or photographic information.

6. The method of claim 1 wherein the electronic analysis of the electronic information accessed utilizes statistical algorithms based on the theories of oriental medicine.

7. The method of claim 1 wherein the oriental recommendation output includes probabilities assigned to each of a selected one or more oriental medicine diagnoses.

8. The method of claim 1 wherein the oriental recommendation output includes a list of symptoms for each of a selected one or more oriental medicine diagnoses.

9. The method of claim 1 wherein the oriental recommendation output includes herbal and acupuncture treatment recommendations.

10. The method of claim 1 further including the step of receiving feedback from the patient or practitioner regarding the outcome of one or more of the selected oriental medicine recommendations.

11. The method of claim 1 wherein the electronic analysis of the electronic information includes biometric analysis.

12. A system for use in oriental medicine comprising:
a controller that receives electronic information from a patient relating to a medical complaint via a user interface; accesses electronic information relating to the patient's medical complaint and oriental medicine recommendations; electronically analyzes the electronic information accessed to select one or more oriental medicine recommendations related to the patient's medical complaint; outputs the selected one or more oriental medicine recommendation; and allows a user to provide additional electronic information such that any additional electronic information provided may be electronically analyzed in combination with accessed information relating to the patient's medical complaint and oriental medicine recommendations to select one or more oriental medicine recommendations related to the patient's medical complaint, wherein the selected one or more oriental medicine recommendations may be output.

13. The system of claim 12 wherein at least a portion of the electronic information relating to the patient's medical complaint and oriental medicine recommendations is stored in one or more databases.

14. The system of claim 12 wherein the output is transmitted via a second user interface.

15. The system of claim 12 wherein the first user interface is not located at the practitioner's office.

16. The system of claim 12 further comprising a bioelectric device that provides the controller bioelectric information regarding the patient.

17. A computer-readable medium having computer-executable instructions for use in oriental medicine, the computer-executable instructions causing the system to perform the steps of:
receiving electronic information from a patient relating to a medical complaint;
accessing electronic information relating to the patient's medical complaint and oriental medicine recommendations;
electronically analyzing the electronic information accessed to select one or more oriental medicine recommendations related to the patient's medical complaint;
outputting the selected one or more oriental medicine recommendation; and
allowing a user to provide additional electronic information such that any additional electronic information provided may be electronically analyzed in combination with accessed information relating to the patient's medical complaint and oriental medicine recommendations to select one or more oriental medicine recommendations related to the patient's medical complaint, wherein the selected one or more oriental medicine recommendations may be output.

18. The computer-readable medium of claim 17 wherein the computer-executable instructions further cause the system to perform the step of providing to a patient a questionnaire related to the patient's received medical complaint, wherein the questionnaire collects additional information from the patient relevant to the electronic analysis.

19. The computer-readable medium of claim 17 wherein the computer-executable instructions further cause the system to perform the step of storing electronic records relating to one or more of: the patient; a practitioner; a diagnosis; a treatment plan; and feedback from the patient or practitioner.

20. The computer-readable medium of claim 17 wherein the computer executable instructions further cause the system to perform the steps of requiring registration for each of the patient and a practitioner.
